(19) United States
(12) Patent Application Publication
(10) Pub. No.: US 2018/0191271 A1
(43) Pub. Date: Jul. 5, 2018

(54) DETECTING RESONANCE FREQUENCY IN LLC SWITCHING CONVERTERS FROM PRIMARY SIDE

(71) Applicant: Texas Instruments Incorporated, Dallas, TX (US)

(72) Inventors: Salvatore Giombanco, Cassaro (SR) (IT); Saurav Bandyopadhyay, Dallas, TX (US); Salvatore Vincenzo Capici, Belpasso (CT) (IT)

(21) Appl. No.: 15/395,971

(22) Filed: Dec. 30, 2016

(51) Int. Cl. H02M 7/48; H02M 7/217; H02M 7/04; H02M 7/523; H02M 1/42; H02M 3/07

(52) U.S. Cl. CPC H02M 7/4826; H02M 7/217; H02M 7/043; H02M 7/523; H02M 2007/4811; H02M 3/07; H02M 2007/4818; H02M 2007/4815; H02M 1/4241

(57) ABSTRACT

Embodiments includes systems, methods, and apparatuses for determining a resonant frequency of an LLC converter via a primary side of the LLC converter. In one embodiment, a circuit comprises an LLC converter and a resonant frequency determination unit, the resonant frequency determination unit configured to monitor electrical current on the primary side of the LLC converter, isolate a portion of the electrical current, determine, based on the portion of the electrical current, a crossing point, and determine, based on the crossing point, a resonant frequency of the LLC converter.

### FIELD OF THE INVENTION

This invention relates generally to LLC converters and, more particularly, to driving LLC converters at their resonant frequency.

### BACKGROUND OF THE INVENTION

LLC converters are most efficient when operating at their resonant frequency. Small deviations of the switching frequency of an LLC converter can have significant impacts on its efficiency. Consequently, maintaining operation of an LLC converter at, or close to, its resonant frequency is important in maintaining an efficient system. Current approaches to driving an LLC converter at its resonant frequency focus on monitoring the secondary side of the LLC converter to determine its resonant frequency. The information gathered at the secondary side is then provided to a driving mechanism for the LLC converter. The driving mechanism is on the primary side of the LLC converter. Consequently, monitoring an LLC converter from the secondary side introduces additional complexities (e.g., an increased number of components) and costs.

### BRIEF DESCRIPTION OF THE DRAWINGS

Embodiments of the invention are illustrated in the figures of the accompanying drawings in which:

FIG. 1 depicts an example LLC converter 100 including a resonant frequency determination unit 110, according to some embodiments;

FIGS. 2A-2C are waveforms associated with an LLC converter, according to some embodiments;

FIG. 3 depicts the primary side of an example LLC converter including a current suppressor 312 and a detector 310, according to some embodiments;

FIG. 4 depicts example circuitry of an example resonant frequency determination unit 400, according to some embodiments

FIG. 5 is a flow chart depicting example operations for determining a resonant frequency for an LLC converter by monitoring current on the primary side of the LLC converter, according to some embodiments.

### DETAILED DESCRIPTION

As previously discussed, maintaining operation of an LLC converter at its resonant frequency helps maximize the efficiency of the LLC converter. Current approaches rely on measurements taken on the secondary side of the LLC converter. Typically, these systems sense zero crossings of the current flowing through the secondary side of the rectifier. These approaches measure current on the secondary side because the current on the secondary side is isolated from the magnetizing current from the transformer. That is, the current can be monitored without having to account for the magnetizing current. While this allows for a direct measurement of current (i.e., the current is isolated from the magnetizing current), it introduces additional costs and complexities. One reason that measuring current on the secondary side of the LLC converter introduces additional costs and complexities is due to the fact that information must be transmitted back to the primary side of the LLC converter through an isolation barrier. The additional componentry necessary to facilitate this transmission increases the complexity of the circuit, and thus, the cost of the circuit.

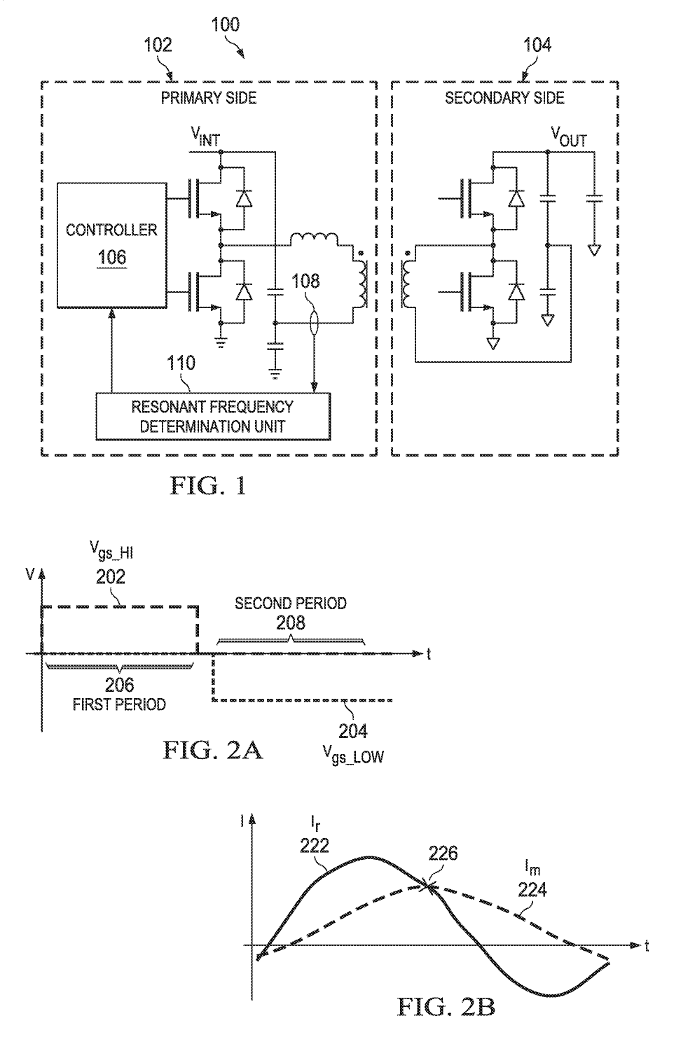

Embodiments of the inventive subject matter allow an LLC converter to be driven at its resonant frequency without measuring current at the secondary side of the LLC converter. Put simply, embodiments of the inventive subject matter obviate the need for the additional componentry, and cost, associated with monitoring information on the secondary side of the LLC converter and transmitting that information to the primary side of the LLC converter. Instead of monitoring the secondary side of the LLC converter, embodiments of the inventive subject matter monitor current on the primary side of the LLC converter. However, as discussed above, the current on the primary side includes both a sinusoidal portion and a magnetizing current produced by the transformer. Because the current on the primary side of the LLC converter includes both a sinusoidal portion and a magnetizing current, the sinusoidal portion of the current is isolated from the magnetizing current. In some embodiments, the sinusoidal portion of the current is isolated from the magnetizing current by performing mathematical calculations (e.g., calculating the second order derivative) on the current. Once the sinusoidal portion of the current is isolated, zero crossings of the sinusoidal portion of the current can be detected and the half bridge switches can be driven based on the zero crossings. In some embodiments, a resonant frequency determination unit is utilized to monitor current on the primary side of an LLC converter and determine a resonant frequency for the LLC converter. FIG. 1 provides an overview of an example LLC converter including a resonant frequency determination unit, while FIG. 3 provides additional information regarding an example resonant frequency determination unit.

FIG. 1 depicts an example LLC converter 100 including a resonant frequency determination unit 110, according to some embodiments. The LLC converter 100 has a primary side 102 and a secondary side 104. The resonant frequency determination unit 110 is located on the primary side 102. The resonant frequency determination unit 110 is able to determine the resonant frequency of the LLC converter 100 based on measurements taken at the primary side 102 of the LLC converter 100. More specifically, the resonant frequency determination unit 110 monitors the primary side current of the LLC converter 100 via a sensor 108 (e.g., a current sensor). As previously discussed, the primary side current (i.e., the resonant current) includes both a sinusoidal portion and a ramp current (i.e., a magnetizing current caused by the transformer). The resonant frequency determination unit isolates the sinusoidal portion of the primary side current so that the resonant frequency can be detected. In one embodiment, the resonant frequency determination unit 110 isolates the sinusoidal portion of the primary side current by taking the second order derivative of the primary side current. The resonant frequency determination unit 110 analyzes the sinusoidal portion of the primary side current to determine the resonant frequency of the LLC converter 100. In some embodiments, the resonant frequency determination unit 110 determines the resonant frequency based on zero-crossings of the sinusoidal portion. The controller 106 receives resonant frequency information from the resonant frequency determination unit 110 and drives the LLC converter 100 at the resonant frequency.

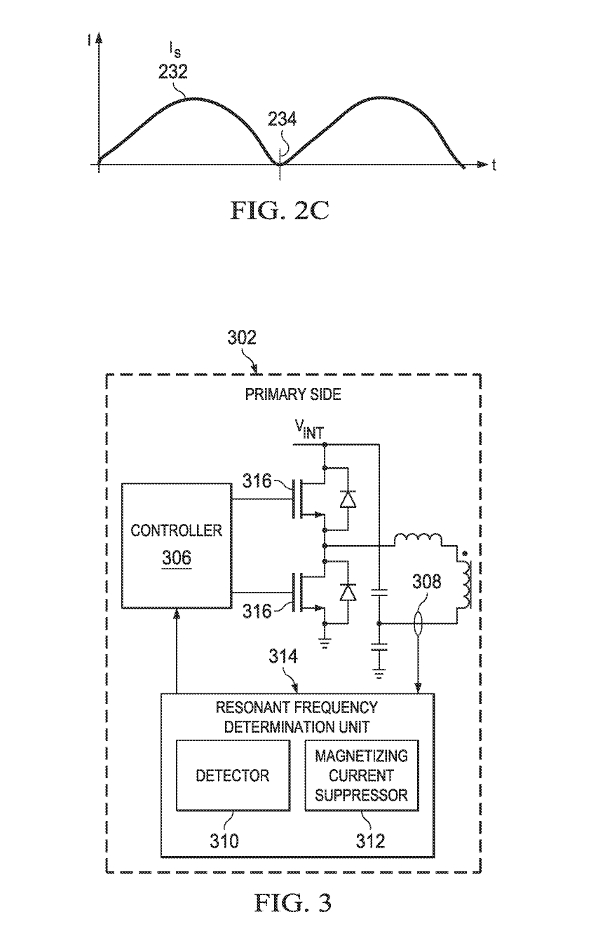

While the discussion of FIG. 1 provides an overview of a circuit capable of determining a resonant frequency for an LLC converter via the primary side of the LLC converter, the discussion of FIGS. 2A-2C provides additional information regarding the primary side current of an LLC converter.

FIG. 2A depicts a first waveform 202 and a second waveform 204. The first waveform 202 indicates the voltage across a first switch of an LLC converter (e.g., V_{gs} of a high side switch), and the second waveform 204 indicates the voltage across a second switch of the LLC converter (e.g., V_{gs} of a low side switch). As can be seen from FIG. 2A, the first switch is on during a first period 206 and the second switch is on during a second period 208. When an LLC converter is driven at its resonant frequency, switching from the first period 202 to the second period 208 occurs at the point in time at which the primary side current crosses the magnetizing portion of the primary side current, as depicted in FIG. 2B.

FIG. 2B depicts a resonant current waveform 222 and a magnetizing current waveform 224. The primary side current of an LLC converter is a composite of both a sinusoidal portion and the magnetizing current waveform 224. When operating at its resonant frequency, the LLC converter switches between the high side and low side switches on the primary side when the resonant current reaches the magnetizing current. This occurs when the resonant current waveform 222 and the magnetizing current waveform 224 intersect, as indicated by an intersection marking 226.

FIG. 2C depicts a sinusoidal portion waveform 232. As discussed above, the primary side current of an LLC converter is a composite of both a sinusoidal portion, depicted in FIG. 2C by the sinusoidal portion waveform 232, and a magnetizing portion. The sinusoidal portion waveform 232 depicts the sinusoidal portion of the primary side current isolated form the magnetizing portion. A resonant frequency determination unit can determine the resonant frequency of an LLC converter based on the zero-crossings of the sinusoidal portion. An example zero-crossing of the sinusoidal portion waveform 232 is indicated by a line 234. Because the zero-crossing of the sinusoidal portion occurs when the resonant current reaches the magnetizing current, the intersection marking 226 of FIG. 2B is aligned with the line 234 of FIG. 2C. In other words, the intersection of the resonant current waveform 222 and the magnetizing current waveform (both of FIG. 2B) is aligned with the zero-crossing of the sinusoidal portion waveform 232 of FIG. 2C.

While the discussion of FIGS. 2A-2C describes waveforms associated with an LLC converter, the discussion of FIG. 3 provides additional information regarding an example LLC converter including a resonant frequency determination unit.

FIG. 3 depicts the primary side 302 of an example LLC converter including a magnetizing current suppressor 312 and a detector 310, according to some embodiments. The primary side 302 also includes half bridge switches 316 and a controller 306. The resonant frequency determination unit 314 monitors current on the primary side 302 (i.e., the primary side current or resonant current) of the LLC converter and, based on the primary side current, determines the resonant frequency of the LLC converter.

The resonant frequency determination unit monitors the primary side current via a sensor 308. The current on the primary side 302 (i.e., the resonant current) includes a sinusoidal portion and a magnetizing portion (i.e., the magnetizing current) caused by the transformer. To drive the LLC converter at its resonant frequency, the controller 306 should switch the half bridge switches 316 when the primary side current crosses the magnetizing current. To find this crossing point, the resonant frequency determination unit 314 first isolates the sinusoidal portion from the magnetizing portion. In the example LLC converter, the resonant frequency determination unit 314 utilizes the magnetizing current suppressor 312 to isolate the sinusoidal portion from the magnetizing portion. In one embodiment, the current suppressor 312 isolates the sinusoidal portion from the magnetizing portion by taking the second order derivative of the primary side current.

After isolating the sinusoidal portion of the primary side current, the resonant frequency determination unit 314 determines the intersections of the primary side current and the magnetizing portion. In the example LLC converter, the resonant frequency determination unit 314 utilizes a detector 310 to determine the intersections. As previously discussed, the zero-crossings of the sinusoidal portion correspond to the intersections of the primary side current and the magnetizing current. Consequently, in one embodiment, the detector 310 can be a comparator that detects the zero-crossings of the sinusoidal portion to determine the intersections of the primary side current and the magnetizing current. Based on the zero-crossings of the sinusoidal portion, the resonant frequency determination unit 314 determines the resonant frequency of the LLC converter.

In some embodiments, the resonant frequency determination unit 314 determines the resonant frequency of the LLC converter on a cycle-by-cycle basis. In such embodiments, the resonant frequency determination unit 314 can adapt to changes in the LLC converter to ensure that the controller 306 continues driving the half bridge switches 316 at the resonant frequency.

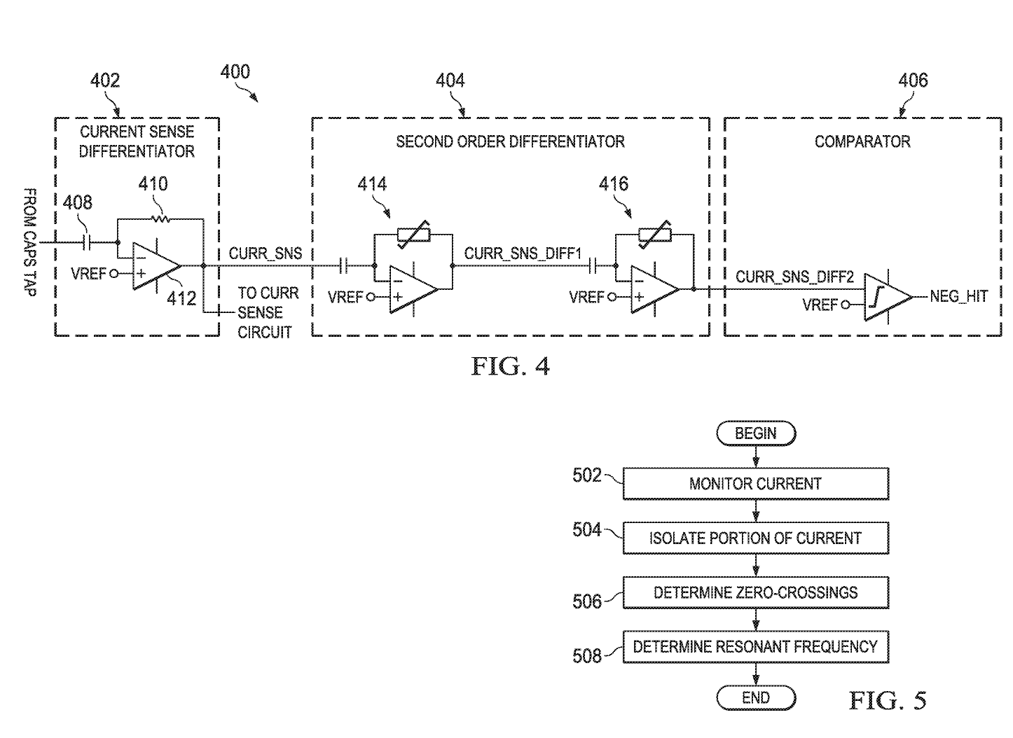

While the discussion of FIG. 3 describes a specific example of a resonant frequency detection unit, the discussion of FIG. 4 describes example circuitry of a resonant frequency determination unit that can determine the resonant frequency of an LLC converter based on the primary side current of the LLC converter.

FIG. 4 depicts example circuitry of an example resonant frequency determination unit 400, according to some embodiments. The resonant current determination unit 402 includes a current sense differentiator 402, a second order differentiator 404, and a comparator 406. The current sense differentiator 402 senses current on the primary side of the LLC converter and, in the example depicted in FIG. 4, includes a first capacitor 408, a resistor 410, and an operational amplifier (an “Op Amp”) 412. The second order differentiator 404 isolates the sinusoidal portion of the primary side current form the magnetizing portion by taking the second order derivative of the primary side current. The second order differentiator 404 consists of two differentiators: a first differentiator 414 and a second differentiator 416. In the example depicted in FIG. 2, each of the first differentiator 414 and the second differentiator include an Op Amp and a resistor. The comparator 406 compares the output of the second order differentiator 404 (i.e., the sinusoidal portion of the primary side current) to a reference voltage. Based on this comparison, the comparator 406 determines the zero-crossings of the sinusoidal portion of the primary side current.

While the discussion of FIG. 4 describes example circuitry of a resonant frequency determination unit that can determine the resonant frequency of an LLC converter based on the primary side current of the LLC converter, the discussion of FIG. 5 provides example operations for determining the resonant frequency of an LLC converter via the primary side of the LLC converter.

FIG. 5 is a flow chart depicting example operations for determining a resonant frequency for an LLC converter by monitoring current on the primary side of the LLC converter, according to some embodiments. The flow begins at block 502.

At block 502, current is monitored. For example, a resonant frequency determination unit can monitor the current on the primary side of an LLC converter. The resonant frequency determination unit can monitor the current via a sensor. The sensor can be any type suitable for measuring or monitoring current, such as an ammeter. The flow continues at block 504.

At block 504, a portion of the current is isolated. For example, the resonant frequency determination unit can isolate a portion of the current. In an LLC converter, the monitored current (i.e., the primary side current or resonant current) is the combination of a sinusoidal portion associated with the half bridge switches and a magnetizing portion associated with the transformer. In some embodiments, the resonant frequency determination unit isolates the sinusoidal portion of the current. As one example, the resonant frequency determination unit can isolate the sinusoidal portion of the current by determining the second order derivative of the monitored current. In some embodiments, the resonant frequency determination unit includes a current suppressor that isolates the sinusoidal portion of the current. The flow continues at block 506.

At block 506, zero-crossings are determined. For example, the resonant frequency determination unit determines zero-crossings of the sinusoidal portion. As previously discussed, the zero-crossings of the sinusoidal portion correspond to the intersections of the primary side current and the magnetizing current. In an LLC converter, the zero-crossings are indicative of the resonant frequency of the LLC converter. In some embodiments, the resonant frequency determination unit includes a detector that determines the zero-crossings. The flow continues at block 508.

At block 508, a resonant frequency is determined. For example, the resonant frequency determination unit can determine the resonant frequency. In an LLC converter, the resonant frequency determination unit determines the resonant frequency based on the zero-crossings of the sinusoidal portion. To drive the LLC converter at its resonant frequency, the half bridge switches should alternate at the zero-crossings.

What is claimed is:

1. A method for determining resonant frequency for an LLC converter on a primary side of the LLC converter, the method comprising:
monitoring, on the primary side of the LLC converter by a resonant frequency determination unit, electrical current;
isolating, by the resonant frequency determination unit, a portion of the electrical current;
determining, by the resonant frequency determination unit, based on the portion of the electrical current, a zero-crossing; and
determining, by the resonant frequency determination unit based on the zero-crossing, the resonant frequency for the LLC converter.

2. The method of claim 1, wherein the electrical current is a resonant current that is a combination of a sinusoidal current and a magnetizing current.

3. The method of claim 2, wherein the isolating the portion of the electrical current includes isolating the sinusoidal current.

4. The method of claim 2, wherein the resonant frequency determination unit includes a magnetizing current suppressor.

5. The method of claim 2, wherein the resonant frequency determination unit includes a comparator, and wherein the determining the zero-crossing comprises determining, by the comparator, a zero-crossing of the sinusoidal current.

6. The method of claim 1, wherein the isolating a portion of the electrical current comprises:
calculating, by the resonant frequency determination unit, a second order derivative based on the electrical current.

7. The method of claim 1, further comprising:
driving, by a controller, the LLC converter at the resonant frequency.

8. The method of claim 1, wherein the resonant frequency determination unit comprises a current sense differentiator, a second order differentiator, and a comparator.

9. The method of claim 8, wherein the current sense differentiator comprises a capacitor, a first resistor, and a first operational amplifier, and wherein the second order differentiator comprises two differentiators, each differentiator comprising a second operational amplifier and a second resistor.

10. A circuit comprising:
an LLC converter having a primary side, the LLC converter including a resonant frequency determination unit, the resonant frequency determination unit configured to:
monitor electrical current on the primary side of the LLC converter;
isolate a portion of the electrical current;
determine, based on the portion of the electrical current, a zero-crossing; and
determine, based on the zero-crossing, a resonant frequency for the LLC converter.

11. The circuit of claim 10, wherein the electrical current is a resonant current that is a combination of a sinusoidal portion and a magnetizing portion.

12. The circuit of claim 11, wherein the resonant frequency determination unit isolates the sinusoidal portion of the electrical current.

13. The circuit of claim 11, wherein the resonant frequency determination unit includes a magnetizing current suppressor.

14. The circuit of claim 11, wherein the resonant frequency determination unit includes a comparator, wherein the zero-crossing is a zero-crossing of the sinusoidal portion, and wherein the zero-crossing of the sinusoidal portion corresponds to an intersection between the resonant current and the magnetizing portion.

15. The circuit of claim 10, wherein the resonant frequency determination unit isolates a portion of the electrical current by calculating a second order derivative based on the electrical current.

16. The circuit of claim 10, wherein the resonant frequency determination unit is further configured to:
cause the LLC converter to be driven at the resonant frequency.

17. The circuit of claim 10, wherein the resonant frequency determination unit comprises:
a current sense differentiator, wherein the current sense differentiator includes a capacitor, a first resistor, and a first operational amplifier;
a second order differentiator, wherein the second order differentiator comprises two differentiators, each differentiator including a second operational amplifier and a second operational amplifier; and
a comparator, wherein the comparator is connected in series with the second order differentiator.

18. A system comprising:
an LLC converter having a primary side; and
a resonant frequency determination unit, the resonant frequency determination unit configured to monitor electrical current on the primary side of the LLC converter, wherein the electrical current is a resonant current that is a combination of a sinusoidal current and a magnetizing current, wherein the resonant frequency determination unit comprises:
a current suppressor, the current suppressor configured to:
isolate the sinusoidal current of the electrical current by calculating a second order derivative of the electrical current; and
a comparator configured to:
determine, based on the sinusoidal current, a zero-crossing, wherein the zero-crossing corresponds to an intersection between the resonant current and the magnetizing current; and
determine, based on the zero-crossing, a resonant frequency of the LLC converter.

19. The system of claim 18, wherein the current suppressor is a magnetizing current suppressor.

20. The system of claim 18, wherein the current suppressor includes two differentiators connected in series, wherein each of the two differentiators comprises an operational amplifier and a resistor connected in parallel.
